(19) United States
(12) Patent Application Publication
(10) Pub. No.: US 2008/0099966 A1
(43) Pub. Date: May 1, 2008

(54) Powertrain mount for vehicle

(75) Inventor: Tae Sup Kim, Busan-si (KR)

Correspondence Address: ROBERTS, MLOTKOWSKI & HOBBES, P. O. BOX 10064, MCLEAN, VA, 22102-8064, US

(73) Assignee: DTR Co., Ltd., Gyeongsangnam-do (KR)

(21) Appl. No.: 11/593,546

(22) Filed: Nov. 7, 2006

(30) Foreign Application Priority Data
Oct. 25, 2006 (KR) 10-2006-0103810

(51) Int. Cl. F16F 13/00

(52) U.S. Cl. 267/140.12

(57) ABSTRACT

Disclosed is a powertrain mount capable of being installed between a powertrain of a vehicle and a structural body of the vehicle supporting the powertrain to isolate vibration being transmitted between the powertrain and the structural body. The powertrain mount includes a bracket capable of being mounted on the powertrain or the structural body. The bracket has a rubber holder for receiving and supporting a rubber member thereinside. A slant support means is disposed inner side of the rubber holder and disposed slantly with respect to the horizontal plane of the vehicle. The slant support means is provided with a support member connector to which a support member installed in the powertrain can be connected. A rubber member is bonded with outer circumferential surface of the slant support means while surrounding the slant support means. The rubber member is accommodated in the rubber holder in compressed state but not bonded with the bracket to thereby resiliently support between the slant support means and the bracket. The rubber member has a through-hole formed around both ends in slant direction of the slant support means to thereby reduce dynamic stiffness in slant direction.

### BACKGROUND OF THE INVENTION

1. Field of the Invention

The present invention relates to a powertrain mount, more particularly to a powertrain mount which is installed between a powertrain such as an engine or transmission of a vehicle and the vehicle structure such as a sub-frame where the powertrain is installed and supported, to thereby isolate vehicle vibration from being transmitted between the powertrain and the vehicle structure.

2. Background of the Related Art

Vehicle vibration occurs in a wide range of frequencies from low to high frequency bands. The vibration may be transmitted to the vehicle body externally from the road surface via the tire and suspension equipment or internally from the engine via the operating system.

When a vehicle is stopped, idle rotation of the engine produces so called idle vibration, due to fluctuation in torque caused by fuel combustion inside the engine. Such engine vibration is transmitted through the steering wheel to driver's hands, or to car seats and passengers. At this time, the vibration being transmitted varies with vibration level due to the engine state and vibration transmission characteristics of the vehicle body. According to the vibration transmission characteristic, often the vibration frequency being transmitted matches with inherent frequency of the structure of vehicle, the deck cross member, the steering wheel and the muffler to cause resonance, leading to an increased level in the idle vibration.

While traveling at a constant speed on a bumpy road or an unpaved road, the entire vehicle bounces up and down, and experiences rolling and pitching, along with the engine vibration. Resonance between the suspension and the vehicle body results in significant wobbling of the vehicle.

In order to prevent this resonance and isolate vibration transmission between vehicle components such as a powertrain and a sub-frame on which the powertrain is mounted, many attempts have been made. For example, relevant components may be designed to have inherent vibration frequencies different from that of engine vibration, or isolation may be provided in the vibration transmission passageway. The present invention is directed to the latter approach.

A powertrain mount provides a major transmission path through which vibration generated in the powertrain is transmitted to the vehicle body, and thus has significant effects on the idle vibration. Mounting type is categorized into principal axes of inertia type and gravity center type, depending upon support modes thereof, and into 3-points mounting type and 4-points mounting type, depending upon the number of mountings.

Mounting insulators include a rubber type and a liquid-type sealed with rubber. The present invention is related to the former.

In case of a powertrain mount not using liquid, generally rubber is inserted inside of a hollow cylinder member such that outer circumferential face of the cylinder member. Installed near the center of the rubber is a pipe or the like for supporting the engine or the like.

In such a powertrain mount, the outer face of the rubber is bonded with the inner face of the cylinder member. Thus, when a load or displacement is exerted in vertical direction of local coordinate of the mount, the powertrain is supported at the right position by static stiffness, which is a combination of compressive static stiffness and tensile static stiffness.

In addition, dynamic stiffness, a combination of compressive dynamic stiffness and tensile dynamic stiffness, functions to isolate vibration between the powertrain and other structures, while supporting the powertrain being vibrated.

In a powertrain system, idle rotation causes mainly low-frequency vibration. In order to isolate this low-frequency vibration, it is necessary in the coordinate of mount to maintain a low dynamic stiffness in the lateral direction of the mount and to maintain a low dynamic stiffness in the vertical direction of vehicle, which affects high-speed comfort of the vehicle. This applies to isolation of high-frequency vibration which is generated at high-speed traveling of a vehicle.

These characteristics do not exist in the above mount where rubber is filled completely inside of a cylinder member. An improved conventional powertrain mount is shown in FIG. 1.

As shown in FIG. 1, a conventional powertrain mount 100 includes a hollow cylinder member 110. A pair of brackets 120 is attached at both sides respectively of the lower portion of the cylinder member 110. The powertrain mount 100 is attached through the brackets 120 to the vehicle structure such as a sub-frame. The bracket 120 has an L-shaped cross-section when seen from the side. Each face of the bracket 120 is provided with a hole 124 through which the bracket 120 is fixed to the vehicle structure such as a sub-frame, and also a hole 122 to reduce the weight thereof.

Installed inside of the cylinder member 110 are a rubber member 130 and an inner support member 140 supported by the rubber member 130. A metallic ring 112 is forcibly pressure-inserted inner side of the cylinder member 110. The outer face of the rubber member 130 is bonded to the inner face of the metallic ring 112. The rubber member is provided with through-holes 132 and 134 for adjusting supporting properties of the inner support member 140. In this way, the inner support member 140 is supported on the cylinder member 110 via two legs 136 and 137 of the rubber member 130.

The inner support member 140 takes an inverse triangular shape and includes insert holes 142 formed such that an element of engine or transmission is inserted into the insert holes 142 and combined with the inner support member.

The powertrain mount 100 explained referring to FIG. 1 is horizontally installed in a vehicle. Thus, coordinate of the mount matches that of the vehicle. Referring to FIG. 2, the forward/backward direction in the vehicle coordinate matches the lateral direction of the local mount coordinates, and the vertical direction in the vehicle coordinate matches the vertical direction in the local coordinate of the mount.

In the powertrain mount shown in FIG. 1, the rubber is removed near the upper side, near the lower side and near the left and right sides of the inner support member 140. Thus, comparing with another type of mount with the rubber fully filled thereinside, lateral dynamic stiffness is relatively decreased with respect to the mount coordinate and vertical dynamic stiffness is relatively lowered with respect to the vehicle coordinate.

In case of the powertrain mount 100 of FIG. 1, however, when it vibrates in lateral direction, the two legs 136 and 137 still remains in a mixed state of compression and tension and are supported at two points. Thus, control of the vibration becomes complicated. In addition, although improved as compared with the previous technique, it still has a problem that the lateral dynamic stiffness of the mount is higher relative to the static stiffness for supporting the powertrain at the right position.

Furthermore, when the powertrain and the like supported on the mount 100 vibrates in vertical direction, the two legs 136 and 137 of the rubber member 130 isolate the vibration by means of the compressive stiffness and tensile stiffness thereof, depending on the direction of vibration. That is, when the engine or the like bounces upwards, the two legs 136 and 137 of the rubber member 130 isolates the vibration through the tensile stiffness thereof and, when the engine bounces downwards, the two legs 136 and 137 isolates the vibration using the compressive stiffness thereof. In case of using the powertrain mount 100 of FIG. 1, accordingly, the vibration control for the powertrain becomes complicated. In addition, since the rubber member 130 is bonded to the ring member 112 placed inner side of the cylinder member 110 and supported by two legs 136 and 137 at both lower sides of the inner support member 140, disadvantageously the vertical dynamic stiffness of the mount is higher, relative to the static stiffness thereof.

The main purpose of such a conventional powertrain mount is to isolate low-frequency vibration of a vehicle and embraces a problem of degraded isolation effect for high-frequency vibration and also transient vibration during damping process of the produced vibration.

### SUMMARY OF THE INVENTION

It is an object of the present invention to provide a powertrain mount, which has an improved vibration isolation effect for low-frequency vibration, and simultaneously for transient vibration and high-frequency vibration.

Another object of the invention is to provide a powertrain mount, in which, when mounted in a vehicle, lateral dynamic stiffness of the mount is reduced, relatively to conventional products of same static stiffness vertical to the vehicle, to thereby improve the vibration isolation effect for transient vibration and high-frequency vibration.

A further object of the invention is to provide a powertrain mount, which can adjust its mounting angle, depending upon vibration-characteristic of a powertrain to be installed in a vehicle, to thereby be able to adjust the capability of insulating vibration.

In order to accomplish the above objects, according to an aspect of the invention, there is provided a powertrain mount capable of being installed between a powertrain of a vehicle and a structural body of the vehicle supporting the powertrain to isolate vibration being transmitted between the powertrain and the structural body, the powertrain mount comprising: a bracket capable of being mounted on the powertrain or the structural body, the bracket having a rubber holder for receiving and supporting a rubber member thereinside; a slant support means disposed inner side of the rubber holder and disposed slantly with respect to the horizontal plane of the vehicle, the slant support means being provided with a support member connector to which a support member installed in the powertrain can be connected; and a rubber member being bonded with outer circumferential surface of the slant support means while surrounding the slant support means, the rubber member being accommodated in the rubber holder in compressed state but not bonded with the bracket to thereby resiliently support between the slant support means and the bracket, the rubber member having a through-hole formed around both ends in slant direction of the slant support means to thereby reduce dynamic stiffness in slant direction.

In an embodiment, the slant support means is provided with a first slant plane formed at the outer face thereof and slantly with respect to horizontal plane of the vehicle, the rubber holder is slantly disposed with respect to the horizontal plane of the vehicle, opened to both sides and provided with a depressed groove for preventing the rubber member from being released to lateral side, and the outer face of the rubber member has a convex form to be able to pressure-inserted into the depressed groove.

In an embodiment, the bracket is formed integrally with the powertrain or the structural body.

In an embodiment, the bracket is provided with a powertrain connector formed so as to be detachably mounted on the powertrain, the slant support means is provided with a support member connector formed such that a support member installed in the structural body can be connected thereto, the slant support means is provided with a first slant plane formed at the outer face thereof and slantly with respect to horizontal plane of the vehicle, the first slant plane is formed on top face of the slant support means, and a convex portion is formed at bottom face of the slant support means in opposite to the first slant plane.

In an embodiment, the bracket is provided with a powertrain connector formed so as to be detachably mounted on the powertrain, the slant support means is provided with a support member connector formed such that a support member installed in the structural body can be connected thereto, the slant support means is provided with a first slant plane formed at the outer face thereof and slantly with respect to horizontal plane of the vehicle, the first slant plane is formed on top face of the slant support means, and a second slant plane is formed at bottom face of the slant support means in opposite to the first slant plane, the second slant plane being in parallel with the first slant plane.

In an embodiment, the bracket is provided with a structural body connector formed so as to be detachably mounted on the structural body, the slant support means is provided with a support member connector formed such that a support member installed in the powertrain can be connected thereto, the slant support means is provided with a first slant plane formed at the outer face thereof and slantly with respect to horizontal plane of the vehicle, the first slant plane is formed at bottom face of the slant support means, and a convex portion is formed on top face of the slant support means in opposite to the first slant plane.

In an embodiment, the bracket is provided with a structural body connector formed so as to be detachably mounted on the structural body, the slant support means is provided with a support member connector formed such that a support member installed in the powertrain can be connected thereto, the slant support means is provided with a first slant plane formed at the outer face thereof and slantly with respect to horizontal plane of the vehicle, the first slant plane is formed at bottom face of the slant support means, and a second slant plane is formed on top face of the slant support means in opposite to the first slant plane, the second slant plane being in parallel with the first slant plane.

In an embodiment, the first slant plane and the depressed groove facing the first slant plane are disposed in parallel with each other.

In an embodiment, the slant support means is disposed at 25˜45° with respect to the horizontal plane of the vehicle.

In an embodiment, installation angle of the bracket to the powertrain or the structural body is adjusted to adjust inclination angle of the slant plane.

In an embodiment, the rubber holder and the rubber member received therein have a rectangular shape having a longer side in the inclination direction.

### BRIEF DESCRIPTION OF THE DRAWINGS

The above and other objects, features and advantages of the present invention will be apparent from the following detailed description of the preferred embodiments of the invention, in conjunction with the accompanying drawings, in which:

FIG. 1 is an elevation showing an improved conventional powertrain mount;

FIG. 2 shows the coordinate system for the powertrain mount of FIG. 1 and the coordinate system for a vehicle;

FIG. 3 is an elevation illustrating a powertrain mount according to an embodiment of the invention;

FIG. 4 is a sectional view taken along the line I-I in FIG. 3;

FIG. 5 shows the coordinate system of a powertrain mount of the invention and the coordinate system of a vehicle;

FIG. 6 shows an example modified from the powertrain mount of FIG. 3;

FIG. 7 shows a powertrain mount according to another embodiment of the invention;

FIG. 8 shows an example modified from the powertrain mount of FIG. 7; and

FIGS. 9 to 15 are graphs comparing variations in the vibration and noise measured from a vehicle to which a powertrain is installed using a conventional powertrain mount or a powertrain mount of the invention.

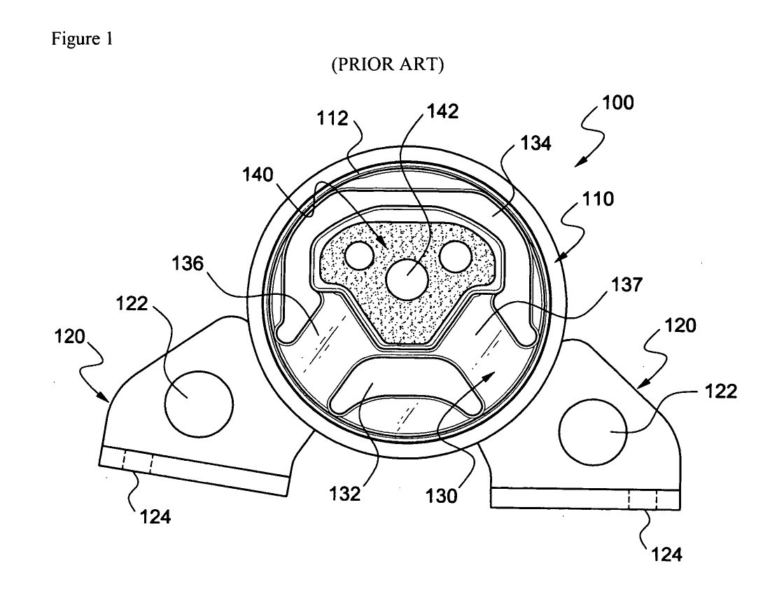

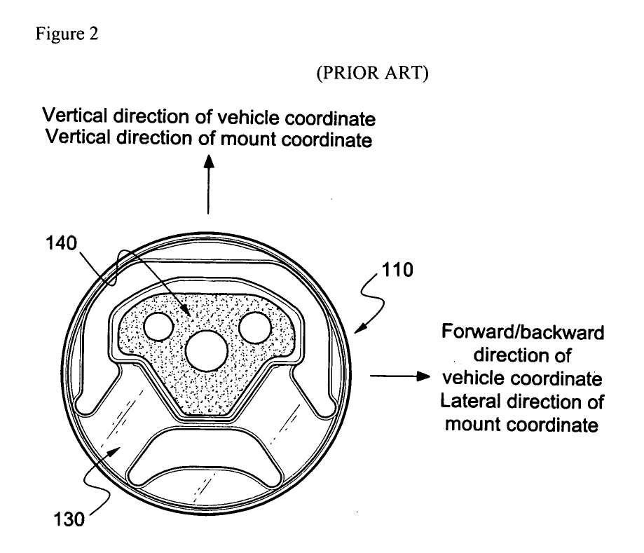

### DETAILED DESCRIPTION OF THE PREFERRED EMBODIMENT

Hereafter, exemplary embodiments of the invention will be described, with reference to the accompanying drawings.

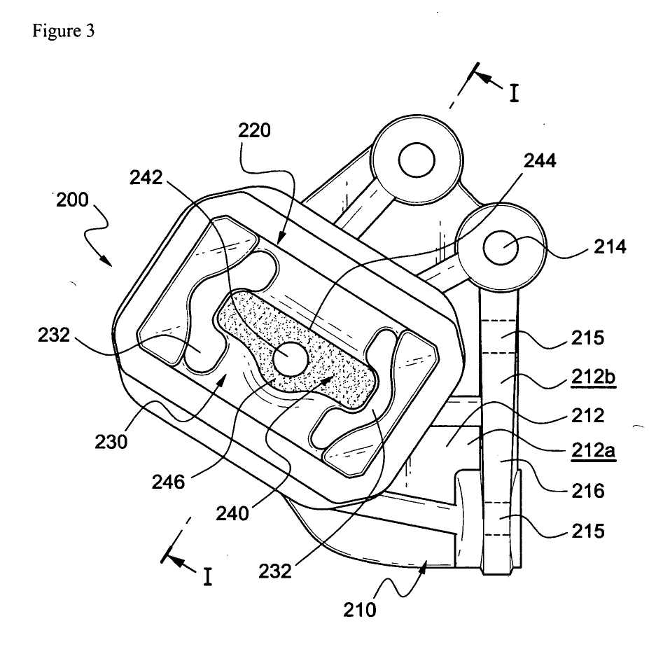

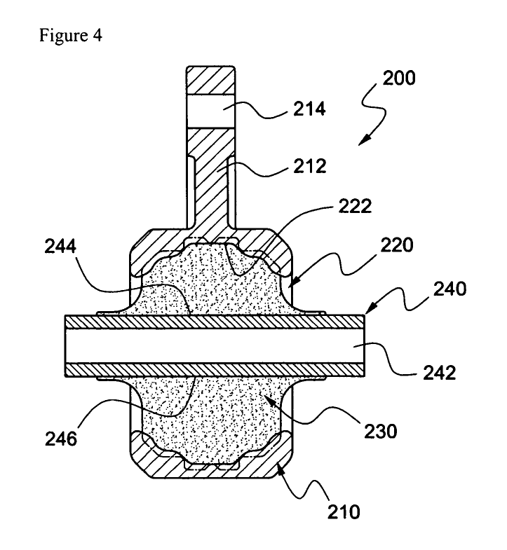

FIGS. 3 and 4 illustrate a powertrain mount according to an embodiment of the invention where the mount of the invention is generally denoted by reference numeral 200.

As shown in FIGS. 3 and 4, the powertrain mount 200 of this embodiment is designed so as to be installed between a powertrain of a vehicle and a structural body of the vehicle supporting the power train to thereby isolate vibration being transmitted between the powertrain and the structural body. The powertrain mount 200 is provided with a bracket 210.

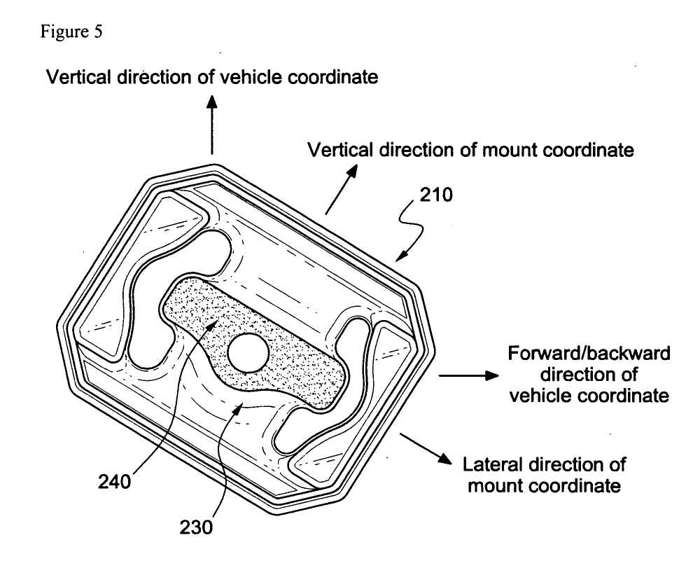

The powertrain mount 200 of FIGS. 3 and 4 includes a slant support means 240 and the like, which are slant-installed in the engine or the like using the bracket 210. As can be seen in FIG. 5, therefore, the coordinate system of the powertrain mount 200 is different from that of the vehicle, i.e., inclined to one side thereof. Accordingly, when the powertrain mount 200 is mounted on the engine or the like of a vehicle, the lateral direction in the local coordinate system of the mount 200 is inclined to one side with respect to the forward/backward direction of vehicle, i.e., the horizontal direction of the vehicle in the vehicle coordinate system. The vertical direction in the mount coordinate system is inclined to one side with respect to the vertical direction in the vehicle coordinate system.

The inclination angle can be adjusted through variations in the bracket 210 structure, the structure of a flange 212 formed in the bracket 210, the positions of connection holes 214 and 215 and the like. In addition, it may vary with the shape of the structural body or the engine where the bracket 210 is mounted. The bracket 210 of the powertrain mount 200 is attached to the powertrain of an engine or transmission or the like. The powertrain mount 200 is provided with a rubber holder 220 at the inner side thereof. The rubber holder 220 is for accommodating and holding a rubber member 230. The sectional view of the rubber holder 220 is shown in FIG. 4.

The rubber holder 220 is slantly disposed with respect to the horizontal plane of a vehicle and opened frontward and backwards, and to the left and right sides. Formed along the inner face of the rubber holder 220 is a depressed groove 222 for preventing the rubber member 230 from escaping through the front and rear openings. The inner face of the rubber holder 220, i.e., the surface of the depressed groove 222 is curved along the transversal direction thereof. Thus, the rubber member 230, received at compressed state, can be further prevented from being released to the outside.

The rubber holder 220 takes a rectangular shape as seen from the front side, and is slantly disposed with respect to the horizontal direction of a vehicle. This rubber holder 220 is not necessarily limited to a rectangular shape and the inclined installation thereof. As shown in FIG. 3, however, it is preferably that the rubber holder 220 is inclined with respect to the horizontal plane of a vehicle and has a rectangular shape having a longer side at the inclined direction.

The inclination angle of the rubber holder 220 may be adjusted, when required, depending upon vibration-properties of the powertrain or chassis of a vehicle. It is preferable that the inclination angle of the rubber holder 220 is in the range of 25 to 45° with respect to the horizontal plane of a vehicle.

The bracket 210 is provided with a flange 212 formed at one outer face of the rubber holder 220. Preferably, this flange 212 is formed of a plane 212a extended outwards from the outer face of the rubber holder 220 and a plane 212b extended perpendicularly to the distal end thereof.

Formed in the flange 212 are connection holes 214 and 215 to be used for connection with an engine or the like. The flange 212 and the connection holes 214 and 215 serve as a powertrain connector 216 for fixing to the powertrain of an engine or transmission, and may be modified in various ways depending upon the structure to which the powertrain is to be mounted.

In some cases, the above-described bracket 210 may be formed integrally with a powertrain, without the powertrain connector 216.

The powertrain mount 200 of this embodiment is provided with a slant support means 240. The slant support means 240 is to be coupled with a support member such as a sub-frame installed in the structure supporting the powertrain. The slant support means 240 is provided with a support member connector 242 having the form of a hole, through which the powertrain mount is connected with a support member such as a sub-frame installed in a structural body supporting a powertrain. This slant support means 240 is disposed inner side of the rubber holder 220 while being supported on a rubber member 230, which will be hereinafter explained. The slant support means 240 is disposed inclined with respect to the horizontal plane of a vehicle. The slant support means 240 includes a first slant plane 244 formed on top thereof. The inclination angle of the first slant plane 244 may be in a range of 25 to 45° with respect to the horizontal plane of a vehicle. In the case where the first slant plane 244 is provided, the inclination angle of the slant support means 240 is determined, with reference to the first slant plane 244.

This first slant plane 244 allows for a decrease in the lateral stiffness of the powertrain mount 200. The first slant plane 244 is referred to be a flat surface, but may be a curved surface, which becomes gradually higher or lower towards the center portion thereof within a range of about 10% of the total length of the slant support means 240.

It is preferable that the slant support means 240 is provided with a first slant plane 244 formed on the outer surface thereof. In the case where the first slant plane 244 does not have a bumpy or irregular surface to the extent not to be considered as a first slant plane, the inclination angle of the slant support means 240 can be determined with reference to the longitudinal centerline thereof.

As shown in FIGS. 3 and 4, the slant support means 240 has a convex portion 246 provided near the center area of the bottom face thereof. This convex portion 246 is disposed at the opposite side of the first slant plane 244 and functions to enhance bonding force between the bottom face of the slant support means 240 and the rubber member 230 placed therebelow. In addition, when kinetic energy of the powertrain exerts a compressive force to the rubber member 230 therebelow due to vibration, the convex portion 246 allows the slant support means 240 to be supported on the rubber member 230 in a stable manner. This convex portion 246 is not always necessary, but, if provided, it is preferable that it is formed at the opposite side to the first slant plane 244, as illustrated in FIG. 3.

As described above, the slant support means 240 is formed preferably of a metallic material having a high abrasive resistance.

As illustrated in the figures, the powertrain mount 200 of this embodiment is provided with a rubber member 230 disposed between the bracket 210 and the slant support means 240. The rubber member 230 may be formed of an elastomer such as synthetic rubbers. This rubber member 230 is bonded with the outer surface of the slant support means 240 while surrounding it. As shown in FIG. 4, the rubber member 230 is formed to have a convex outer surface. The rubber member 230 is not bonded to the bracket 210, but compressed and received in the rubber holder. The contour of the rubber member 230 in non-compressed state is depicted in one-dot-dash line.

The rubber member 230 resiliently supports the slant support means 240 and the bracket 210. The rubber member 240 is provided with through-holes 232 formed around both lateral ends of the slant support means. The through-holes are for reducing dynamic stiffness in lateral direction.

The powertrain mount 200 of this embodiment is one type of pre-loaded rubber bush mount where the rubber member 230 is not directly bonded to the bracket 210, but forcibly pressure-inserted. Thus, when a load or displacement is exerted in the vertical direction of the powertrain mount, only compressive static stiffness functions to support the load because the outer peripheral face of the rubber member 230 is not bonded to the bracket 210.

In addition, in case of a dynamic load, only compressive dynamic stiffness acts to support the dynamic load. Further, since the slant support means 240 is disposed with inclination, low dynamic stiffness can be realized in the lateral direction of the mount.

If only to support same types of powertrain, static stiffness is to be maintained at a same level regardless of the types of mount.

In a powertrain mount 200 shown in FIG. 3, when installed in a vehicle, the compressed rubber member 230 above the first slant plane 244 of the slant support means 240 provides static stiffness required for supporting the powertrain.

If the static stiffness of mount is the same, a low dynamic stiffness is favorable in order to isolate vibration while supporting the powertrain at the right position and also improves isolation effect for transient vibration and high-frequency vibration.

The powertrain mount of the invention, when mounted in a vehicle, relatively reduces characteristics of lateral direction without affecting static stiffness property in the vertical direction of the vehicle, thereby providing a good isolation effect for transient vibration and high frequency vibration.

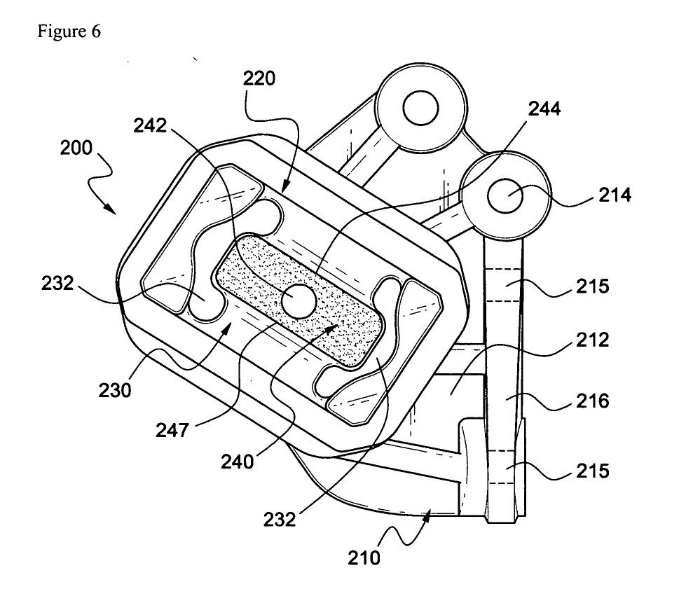

As illustrated in FIG. 6, in some cases, the powertrain mount 200 may have a second slant plane 247 formed in parallel to the first slant plane 244, without forming the convex portion at the bottom face of the slant support means 240. In this case, a depression and prominence is formed in the bottom face of the slant support means 240 to enhance the bonding force between the rubber member 230 and the bottom face of the slant support means 240.

The other elements are the same as in FIGS. 3 to 5.

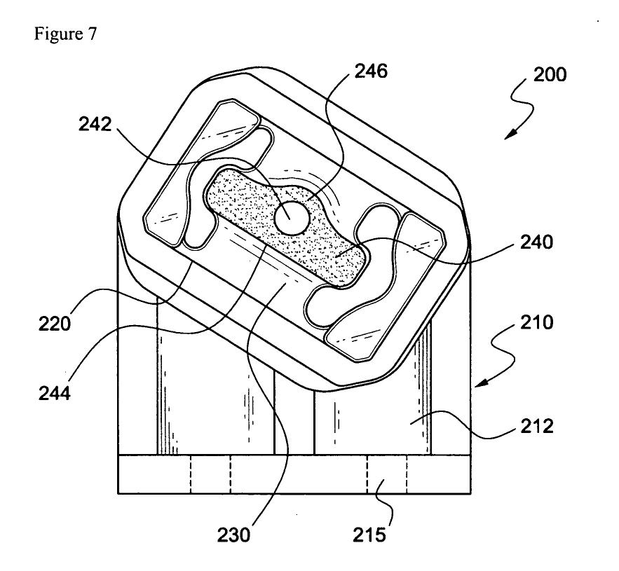

A powertrain mount 200 shown in FIG. 7 is structured such that the bracket 210 is connected to a sub-frame or the like of a vehicle and a support member formed in an engine or transmission is inserted into and combined with the support member connector 242 of the slant support means 240.

As illustrated, the bracket 210 is provided with a flange 212 and connection holes 215 formed at the lower side thereof. The first slant plane 244 is formed at the bottom face of the slant support means 240 and the convex portion 246 is formed at the top face of the slant support means 240.

When a powertrain is mounted on the powertrain mount 200 of FIG. 7, the compressed rubber member 230 below the slant support means 240 supports the powertrain load to take the responsibility for static stiffness of the mount.

Here, preferably the first slant plane 244 and the inner face of the rubber holder 220 of the bracket 210 facing the first slant face 244 are disposed in parallel to each other.

The other elements are the same as in FIGS. 3 to 5.

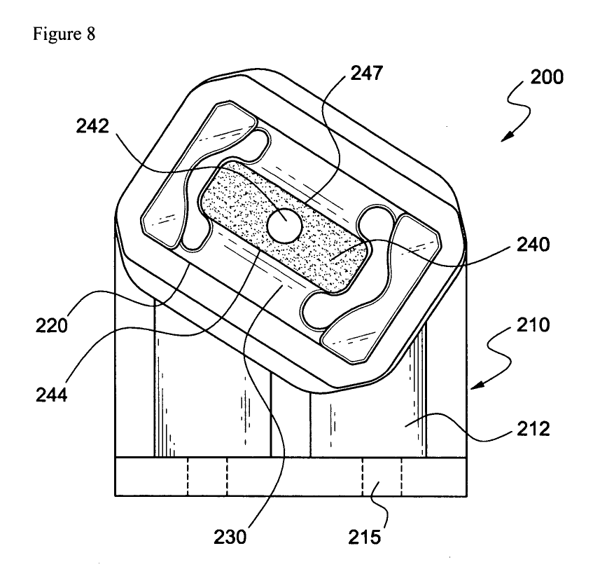

A powertrain mount of FIG. 8 is the same as the mount 200 of FIG. 7, except that a second slant plane 247 is formed at the top face of the slant support means 240.

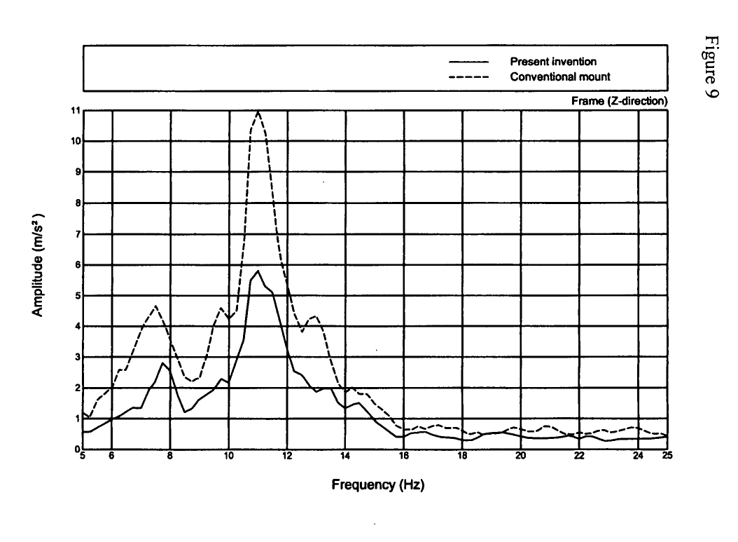

FIG. 9 shows variations in the vertical amplitude (variations in the acceleration) with fluctuation in the frequency, which have been measured during vehicle traveling, using a sensor attached to the vehicle frame to measure frequencies and amplitude. In FIG. 9, the solid line denotes the present invention and the dot line denotes a conventional technology.

Referring to FIG. 9, it can be seen that the present invention exhibits low frame-amplitudes over the entire low frequency range of 5˜25 Hz, as compared with the conventional mount. In particular, it has been found that the amplitude is significantly reduced at the range of 5˜14 Hz.

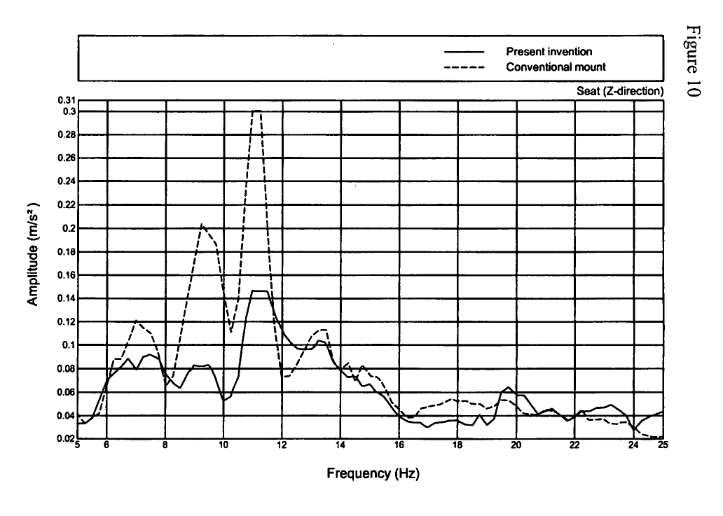

FIG. 10 shows variations in the vertical amplitude with fluctuation in the seat frequency under the same conditions as in FIG. 9. It can be seen that according to the invention, generally the seat amplitude has been attenuated except for a certain range such as 19˜25 Hz, in particular, the seat amplitude has been significantly improved in the range 6˜12 Hz.

It can be seen from the graphs of FIGS. 9 and 10 that the powertrain mount of the invention provides a noticeable improvement in shake and harshness at low-frequency vibration.

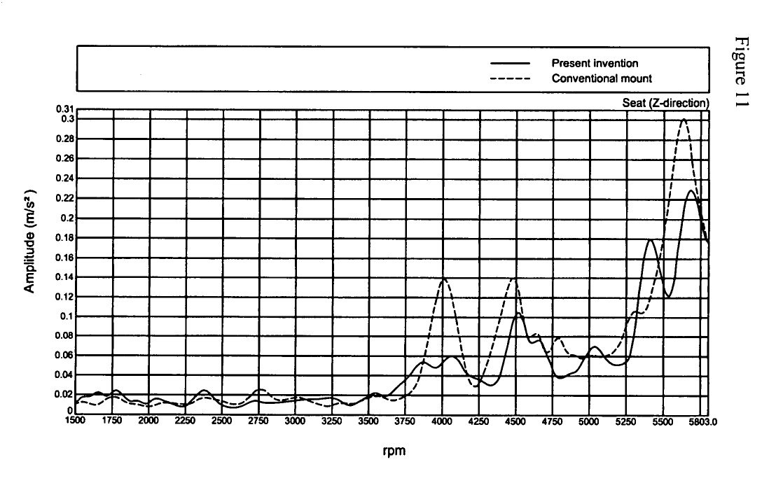

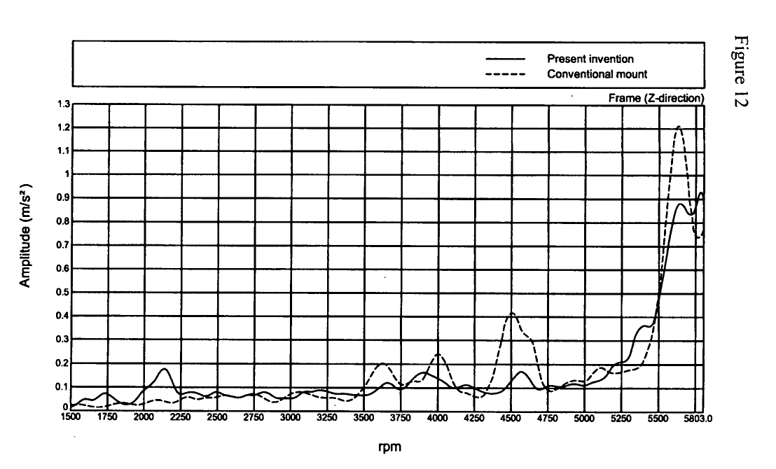

FIGS. 11 and 12 show variations in the vertical amplitude (acceleration) of seat and frame with rpm of a vehicle engine when running.

As can be seen from FIG. 11, the seat amplitude exhibits similar performance at the range of no more than about 3,900 rpm in both cases of the invention and conventional mount, but the invention is much better at the range of above 3,900 rpm.

Referring to FIG. 12, the frame amplitude in the conventional mount exhibits a little better result at the range of no more than 3,500 rpm, but at the range of above 3,500 rpm, the invention exhibits much better results.

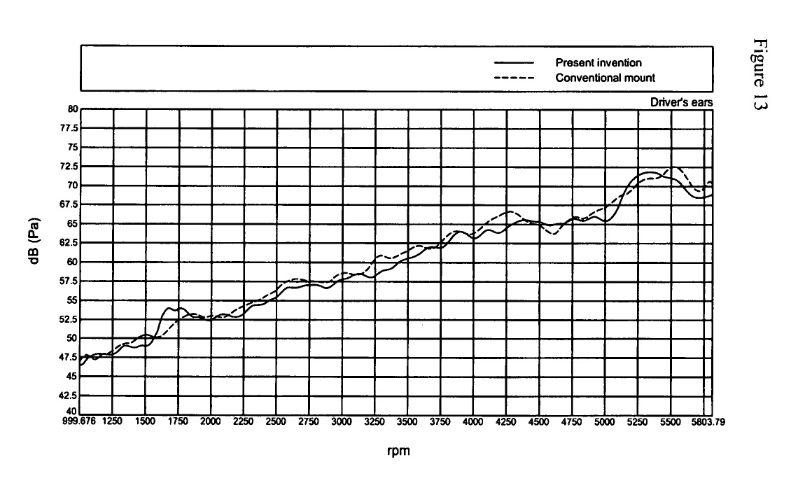

FIG. 13 shows variations in noise level from the driver's ears with fluctuation in rpm when running. It can be seen that the powertrain mount of the present invention shows better results, except for some ranges such as near 1,600 rpm and near 5,250 rpm.

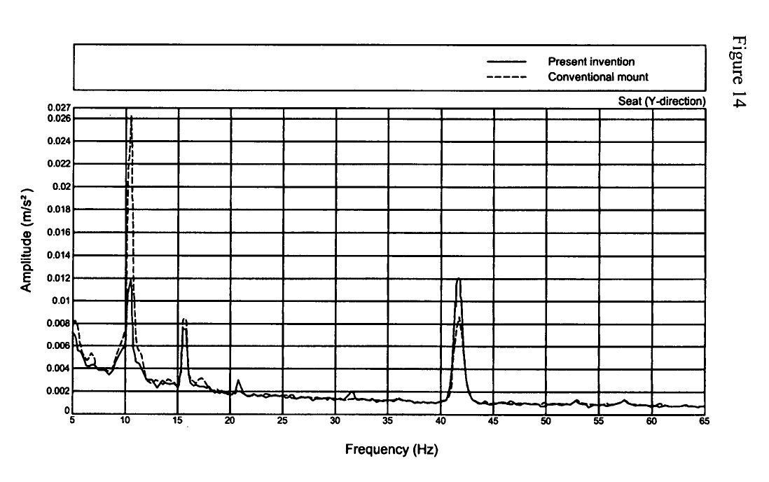

FIG. 14 shows variations in the horizontal amplitude of seat with fluctuation in the frequency when in no-load rotation. Below 20 Hz, the powertrain mount of the invention has a superior amplitude isolation effect to the conventional powertrain mount. Above 20 Hz, both have similar performance.

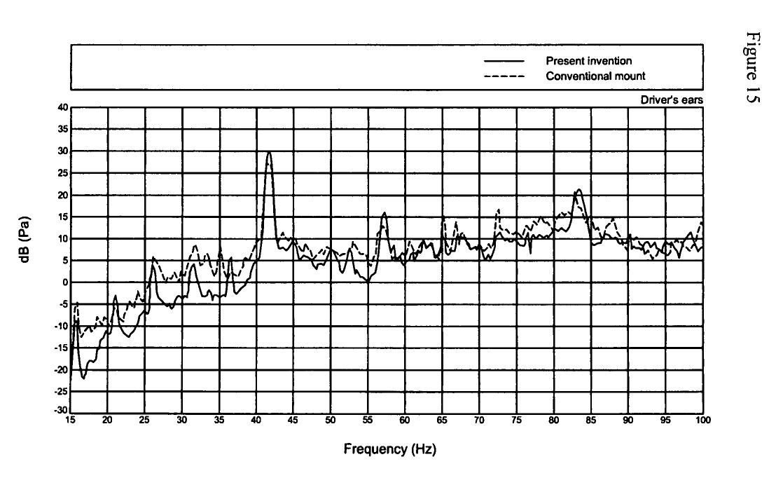

FIG. 15 shows variations in noise level from the driver's ears with fluctuation in the frequency when in no-load rotation. The powertrain mount of the invention is better on the whole, as compared with the conventional powertrain mount, in particular exhibits, below 60 Hz, a significant improvement in the noise level.

Referring to FIGS. 14 and 15, it can be seen that the powertrain mount of the invention provides a significant isolation effect on the lateral vibration of a vehicle when in no-load rotation, and also a noise attenuation effect when in no-load rotation.

As described above, the powertrain mount according to the invention provides significant effects on improving NVH (noise, vibration and harshness) performances in vehicles, which use a common powertrain system, or a powertrain equipped with a multi-displacement system for fuel saving.

In addition, the powertrain mount of the invention provides a significant vibration isolation effect for, in particular, transient vibration and high-frequency vibration, along with isolation of low-frequency vibration.

The powertrain mount of the invention having the above advantageous effects can replace a fluid-sealed mount, which cannot be easily manufactured and maintained, and has a shortened service-life, and also provides a cost-saving effect.

While the present invention has been described with reference to the embodiments, the description is illustrative of the invention and is not to be construed as limiting the invention. Variations and modifications may occur to those skilled in the art, without departing from the spirit and scope of the invention, as defined by the appended claims.

What is claimed is:

1. A powertrain mount capable of being installed between a powertrain of a vehicle and a structural body of the vehicle supporting the powertrain to isolate vibration being transmitted between the powertrain and the structural body, the powertrain mount comprising:
a bracket capable of being mounted on the powertrain or the structural body, the bracket having a rubber holder for receiving and supporting a rubber member thereinside;
a slant support means disposed inner side of the rubber holder and disposed slantly with respect to the horizontal plane of the vehicle, the slant support means being provided with a support member connector to which a support member installed in the powertrain can be connected; and
a rubber member being bonded with outer circumferential surface of the slant support means while surrounding the slant support means, the rubber member being accommodated in the rubber holder in compressed state but not bonded with the bracket to thereby resiliently support between the slant support means and the bracket, the rubber member having a through-hole formed around both ends in slant direction of the slant support means to thereby reduce dynamic stiffness in slant direction.

2. The powertrain mount as claimed in claim 1, wherein the slant support means is provided with a first slant plane formed at the outer face thereof and slantly with respect to horizontal plane of the vehicle, the rubber holder is slantly disposed with respect to the horizontal plane of the vehicle, opened to both sides and provided with a depressed groove for preventing the rubber member from being released to lateral side, and the outer face of the rubber member has a convex form to be able to pressure-inserted into the depressed groove.

3. The powertrain mount as claimed in claim 1, wherein the bracket is formed integrally with the powertrain or the structural body.

4. The powertrain mount as claimed in claim 1, wherein the bracket is provided with a powertrain connector formed so as to be detachably mounted on the powertrain, the slant support means is provided with a support member connector formed such that a support member installed in the structural body can be connected thereto, the slant support means is provided with a first slant plane formed at the outer face thereof and slantly with respect to horizontal plane of the vehicle, the first slant plane is formed on top face of the slant support means, and a convex portion is formed at bottom face of the slant support means in opposite to the first slant plane.

5. The powertrain mount as claimed in claim 1, wherein the bracket is provided with a powertrain connector formed so as to be detachably mounted on the powertrain, the slant support means is provided with a support member connector formed such that a support member installed in the structural body can be connected thereto, the slant support means is provided with a first slant plane formed at the outer face thereof and slantly with respect to horizontal plane of the vehicle, the first slant plane is formed on top face of the slant support means, and a second slant plane is formed at bottom face of the slant support means in opposite to the first slant plane, the second slant plane being in parallel with the first slant plane.

6. The powertrain mount as claimed in claim 1, wherein the bracket is provided with a structural body connector formed so as to be detachably mounted on the structural body, the slant support means is provided with a support member connector formed such that a support member installed in the powertrain can be connected thereto, the slant support means is provided with a first slant plane formed at the outer face thereof and slantly with respect to horizontal plane of the vehicle, the first slant plane is formed at bottom face of the slant support means, and a convex portion is formed on top face of the slant support means in opposite to the first slant plane.

7. The powertrain mount as claimed in claim 1, wherein the bracket is provided with a structural body connector formed so as to be detachably mounted on the structural body, the slant support means is provided with a support member connector formed such that a support member installed in the powertrain can be connected thereto, the slant support means is provided with a first slant plane formed at the outer face thereof and slantly with respect to horizontal plane of the vehicle, the first slant plane is formed at bottom face of the slant support means, and a second slant plane is formed on top face of the slant support means in opposite to the first slant plane, the second slant plane being in parallel with the first slant plane.

8. The powertrain mount as claimed in claim 2, wherein the first slant plane and the depressed groove facing the first slant plane are disposed in parallel with each other.

9. The powertrain mount as claimed in claim 1, wherein the slant support means is disposed at 25˜45° with respect to the horizontal plane of the vehicle.

10. The powertrain mount as claimed in claim 1, wherein installation angle of the bracket to the powertrain or the structural body is adjusted to adjust inclination angle of the slant plane.

11. The powertrain mount as claimed in claim 1, wherein the rubber holder and the rubber member received therein have a rectangular shape having a longer side in the inclination direction.
